(19) United States
(12) Patent Application Publication
(10) Pub. No.: US 2006/0289535 A1
(43) Pub. Date: Dec. 28, 2006

(54) Method of driving organic light-emitting element, display panel for driving the same and display device having the same

(75) Inventors: Si-Duk Sung, Seoul (KR); Chun-Seok Ko, Hwaseong-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/433,342

(22) Filed: May 12, 2006

(30) Foreign Application Priority Data
May 18, 2005 (KR) 10-2005-41732

(51) Int. Cl. H05B 6/72

(52) U.S. Cl. 219/761

(57) ABSTRACT

A method of driving an organic light-emitting element is provided as follows. The organic light-emitting element includes a first switching element electrically connected to a gate line and a data line, a second switching element electrically connected to a bias controlling line and a bias signal line, and a driving element electrically connected to the first and second switching elements to drive the organic light-emitting element. The organic light-emitting element is activated during a first time period of a frame. The organic light-emitting element is deactivated during a second time period of the frame. Therefore, the time for reducing the degradation of the driving elements is increased to maximize the amount of degradation reduction.

### CROSS-REFERENCE TO RELATED APPLICATIONS

The present application claims priority from Korean Patent Application No. 2005-41732, filed on May 18, 2005, the disclosure of which is hereby incorporated herein by reference in its entirety.

### BACKGROUND OF THE INVENTION

1. Field of the Invention

The present invention relates to a method of driving an organic light-emitting element, a display panel for driving the organic light-emitting element and a display device having the organic light-emitting element. More particularly, the present invention relates to an organic light-emitting element capable of stabilizing operation characteristics, a display panel for driving the organic light-emitting element and a display device having the organic light-emitting element.

2. Description of Related Art

A display device, in general, displays images based on data processed by an information processing device. The display device often includes a flat panel display device, which is becoming increasingly popular for characteristics such as small size, light weight, high resolution, etc.

There are different types of flat panel display devices, such as liquid crystal display (LCD) device, field emission display (FED) device, organic light-emitting display (OLED) device, plasma display panel (PDP) device, etc.

The OLED device is a type of display device that includes an organic light-emitting element. The organic light-emitting element is remarkable as a second-generation display element. An organic light-emitting element and a driving thin film transistor (TFT) for driving the organic light-emitting element are formed in each of unit pixel regions of the OLED device.

The driving TFT is divided into a poly-silicon TFT and an amorphous silicon TFT according to the type of active layer that the driving TFT has.

The OLED device having the poly-silicon TFT has characteristics such as long lifetime, improved electrical characteristics, etc. The OLED device having the poly-silicon TFT, however, has a complex manufacturing process and an increased manufacturing cost. In addition, the OLED device having the poly-silicon TFT has a smaller screen size than the OLED device having the amorphous silicon TFT.

The OLED device having the amorphous silicon TFT has a large screen. In addition, the OLED device having the amorphous silicon TFT has a simpler manufacturing process than the OLED device having the poly-silicon TFT.

A voltage is applied to a gate electrode of the amorphous silicon TFT of the OLED device to output a current. The organic light-emitting element is controlled by the outputted current.

When a high voltage is applied to the gate electrode of the amorphous silicon TFT for a long stretch of time, the amorphous silicon TFT is degraded to change a threshold voltage Vth and an amount of the output current of the amorphous-silicon TFT. Therefore, a bias stress stability of the amorphous silicon TFT is degraded.

### SUMMARY OF THE INVENTION

The present invention provides a method of driving an organic light-emitting element capable of reducing the degradation of a threshold voltage to apply a constant current to the organic light-emitting element.

The present invention also provides a display panel for driving the above-mentioned organic light-emitting element.

The present invention also provides a display device having the above-mentioned organic light-emitting element.

For the method of driving an organic light-emitting element, the organic light-emitting element includes a first switching element electrically connected to a gate line and a data line, a second switching element electrically connected to a bias controlling line and a bias signal line, and a driving element that is electrically connected to the first and second switching elements and drives the organic light-emitting element. The organic light-emitting element is activated during a first time period of a frame. The organic light-emitting element is deactivated during a second time period of the frame.

The organic light-emitting element may be activated by applying a gate signal to the gate line. The gate signal is applied to the gate line to turn on the first switching element. As the first switching element become turned-on, the organic light-emitting element may be activated by applying a data signal to the driving element through the data line.

The organic light-emitting element may be deactivated by applying the bias controlling signal to the bias controlling line. The bias controlling signal is applied to the bias controlling line to turn on the second switching element. As the second switching element become turned-on, the organic light-emitting element may be deactivated by applying a negative bias signal to the driving element through the bias signal line.

The first time period may be substantially the same as the second time period. Alternatively, the first time period may be different from the second time period.

A display panel in accordance with one embodiment of the present invention includes an organic light-emitting element, a first switching element, a bias signal line, a bias controlling line, a second switching element and a driving element.

The organic light-emitting element is in a pixel region defined by a gate line transmitting a gate signal, a data line transmitting a data signal, and a power supply line transmitting a driving voltage. The first switching element controls an output of the data signal based on an activation of the gate line. The bias signal line transmits a negative bias signal. The bias controlling line transmits a bias controlling signal. The second switching element controls an output of the negative bias signal based on an activation of the bias controlling line. The driving element activates the organic light-emitting element corresponding to the data signal that passes through the first switching element during a first time period of a frame, and deactivates the organic light-emitting element corresponding to the negative bias signal that passes through the second switching element during a second time period of the frame.

A negative bias signal having a constant level may be applied to the bias signal line. A level of the negative bias signal may have a greater absolute value than a maximum level of the data signal.

The bias controlling line may extend substantially parallel to the gate line.

A display device in accordance with one embodiment of the present invention includes a data driving part, a voltage generating part, a gate driving part, a bias controlling part and a display panel.

The data driving part generates a data signal. The voltage generating part generates a negative bias signal. The gate driving part generates gate signals, in sequence. The bias controlling part generates bias controlling signals, in sequence. The display panel includes an organic light-emitting element and a driving element. With an application of the gate signal to the display panel, the driving element activates the organic light-emitting element based on the data signal. With an application of the bias controlling signal to the display panel, the driving element deactivates the organic light-emitting element based on the negative bias signal.

The display device may further include a timing controlling part that controls the gate driving part and the bias controlling part to delay an output of the bias controlling signal by a certain predetermined time with respect to an output of the gate signal.

The bias controlling part may generate a first bias controlling signal while the organic light-emitting element is being activated. The first bias controlling signal may have a lower voltage level than a turn-on voltage of the second switching element.

In addition, the bias controlling part may generate a second bias controlling signal while the organic light-emitting element is being deactivated. The second bias controlling signal may have a greater level than the turn-on voltage of the second switching element.

A level of the negative bias signal generated from the voltage generating part may have a greater absolute value than a maximum level of the data signal.

According to the method of driving the organic light-emitting element, the display panel for driving the organic light-emitting element and the display device having the organic light-emitting element of the present invention, the time for reducing the degradation of the driving elements is increased enough to maximize the amount of the degradation reduction.

### BRIEF DESCRIPTION OF THE DRAWINGS

The above and other advantages of the present invention will become more apparent by describing in detail exemplary embodiments thereof with reference to the accompanying drawings, in which:

FIG. 1A is a graph showing a relationship between a gate-source voltage and a drain current after a positive biasing;

FIG. 1B is a graph showing a relationship between a gate-source voltage and a drain current after a positive biasing and a subsequent negative biasing;.

FIG. 2 is a graph showing an amount of degradation after a positive biasing and after a positive biasing and a subsequent negative biasing;

FIG. 3 is a circuit diagram illustrating a display panel in accordance with one embodiment of the present invention;

FIGS. 4A to 4D are timing diagrams illustrating a method of driving the display panel shown in FIG. 3;

FIGS. 5A to 5F are timing diagrams illustrating another method of driving the display panel shown in FIG. 3;

FIG. 6 is a circuit diagram illustrating a display panel in accordance with another embodiment of the present invention;

FIGS. 7A to 7D are timing diagram illustrating a method of driving the display panel shown in FIG. 6;

FIG. 8 is a block diagram illustrating a display device in accordance with one embodiment of the present invention; and

FIGS. 9A to 9I are timing diagrams illustrating a method of driving the display device shown in FIG. 8.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the meaning that is commonly understood by one of ordinary skill In the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

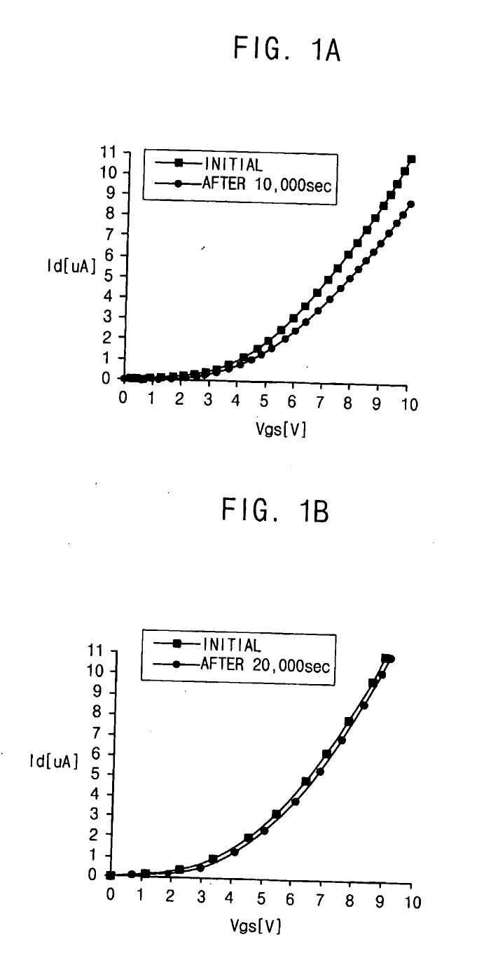

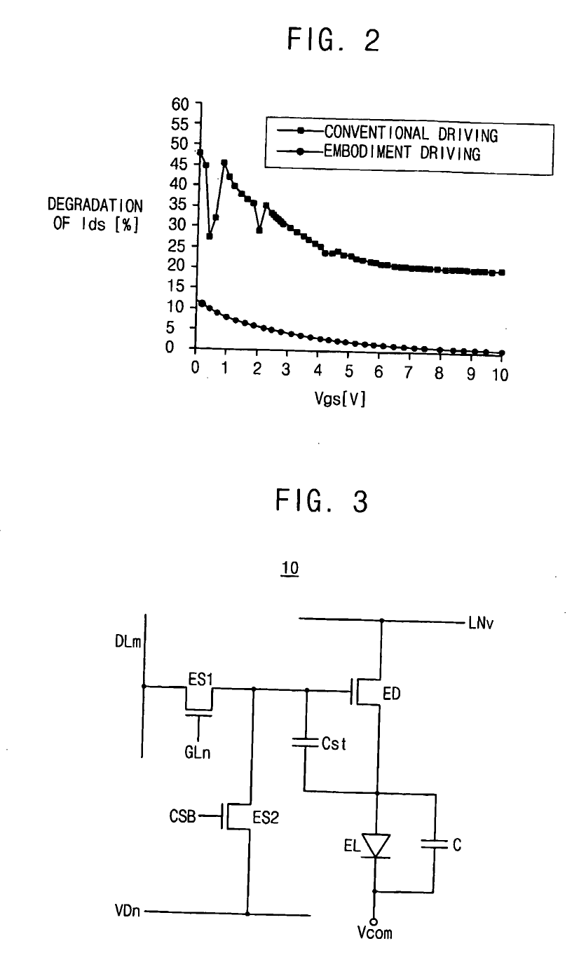

FIG. 1A is a graph showing a relationship between a gate-source voltage and a drain current of a transistor after positive biasing. FIG. 1B is a graph showing a relationship between a gate-source voltage (Vgs) and a drain current (Id) of a transistor after positive biasing and subsequent negative biasing.

Each of the gate-source voltages shown in FIGS. 1A and 1B is a threshold voltage of an amorphous silicon (a-Si) transistor.

Referring to FIG. 1A, an amount of degradation of the a-Si transistor is greatly increased after the a-Si transistor has been driven for about 10,000 sec, as indicated by the decreased drain current at a given gate-source voltage Vgs.

The biasing condition for the a-Si transistor includes a width/length (W/L) ratio of a channel layer of the a-Si transistor that is about 200/3.5 μm. The time period for applying a bias signal is about 10,000 sec. The gate-source voltage Vgs of the a-Si transistor is about 13 V. A drain-source voltage Vds of the a-Si transistor is about 13 V.

Before the positive biasing, the gate-source voltage Vgs of the a-Si transistor is about 8 V, and the drain current Id is about 7 μm. After the a-Si transistor has been driven for about 10,000 sec, the gate-source voltage Vgs of the a-Si transistor is about 8 V, and the drain current Id is about 5.5 μm.

When charges are trapped in the silicon nitride of a gate insulating layer, defect states in the channel layer of the a-Si transistor increase so that the amount of degradation in the a-Si transistor also increases. When the amount of degradation in the a-Si transistor increases, image display quality of an organic light-emitting display (OLED) device deteriorates. The OLED device has the a-Si transistor as a driving element and uses an organic light-emitting element to generate light.

That is, while image is being displayed on the OLED device, the voltage and the current has been constantly applied to the a-Si transistor, thereby increasing the amount of degradation of the a-Si transistor. Since the a-Si transistor is driven for a long stretch of time, the amount of current applied to the organic light-emitting element is decreased. Therefore, the image display quality of the OLED device is deteriorated.

Referring to FIG. 1B, the amount of degradation of the a-Si transistor remains substantially the same as before the bias voltage is applied when the positive biasing is followed by a negative biasing. The total biasing time for the a-Si transistor is about 20,000 sec.

The biasing condition of the a-Si transistor includes a width/length (W/L) ratio of a channel layer of the a-Si transistor that is about 200/3.5 μm. The time period for applying a bias signal is about 20,000 sec. The gate-source voltage Vgs of the a-Si transistor is about 13 V. A drain-source voltage Vds of the a-Si transistor is about 13 V.

Before the positive biasing, the gate-source voltage Vgs is about 8 V, and the drain current Id is about 8 μm. After the a-Si transistor has been driven for about 20,000 sec, the gate-source voltage Vgs is about 8 V and the drain current Id is about 8 μm.

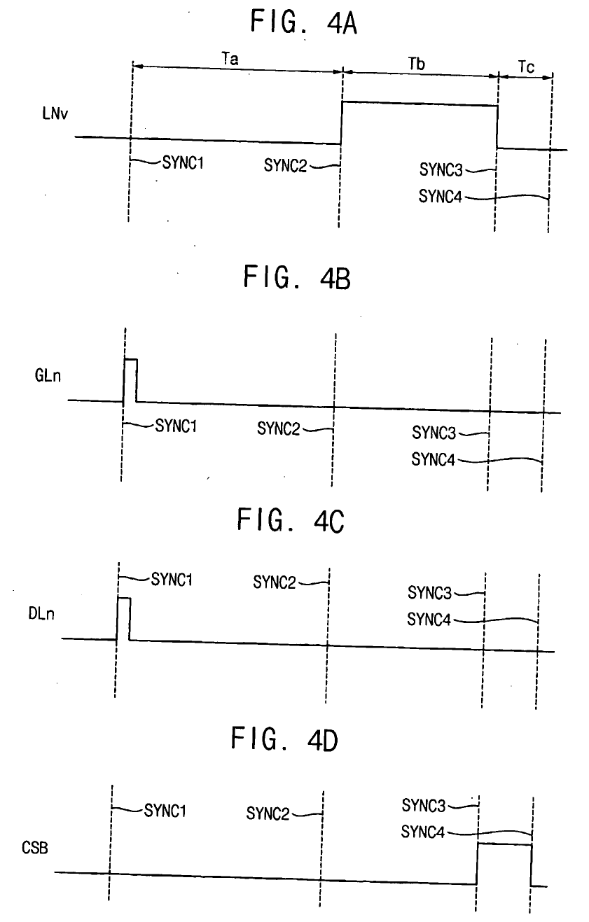

FIG. 2 is a graph showing the amount of degradation after the conventional positive biasing compared to the amount of degradation after applying the biasing method of the invention. The biasing method of the invention includes positive biasing followed by negative biasing.

Referring to FIGS. 1A and 2, when only the positive bias with a gate-source voltage Vgs of about 0 V to about 2 V is applied to the a-Si transistor, an amount of degradation of the drain-source current Ids is about 35% to about 50%. In addition, the amount of degradation of the drain-source current Ids is decreased to about 20%, as a level of the gate-source voltage Vgs is increased.

Referring to FIGS. 1B and 2, when the positive bias and the subsequent negative bias having a gate-source voltage Vgs of about 0 V to about 2 V are applied to the a-Si transistor in sequence, the amount of degradation of the drain-source current Ids is about 5% to about 10%. This is significantly lower than the 35-50% degradation experienced when only positive biasing is applied. In addition, the amount of the degradation of the drain-source current Ids decreases to about 0%, as the level of the gate-source voltage Vgs increases.

Sequentially applying a positive bias and a negative bias to the a-Si transistor decreases the amount of degradation experienced by the a-Si transistor.

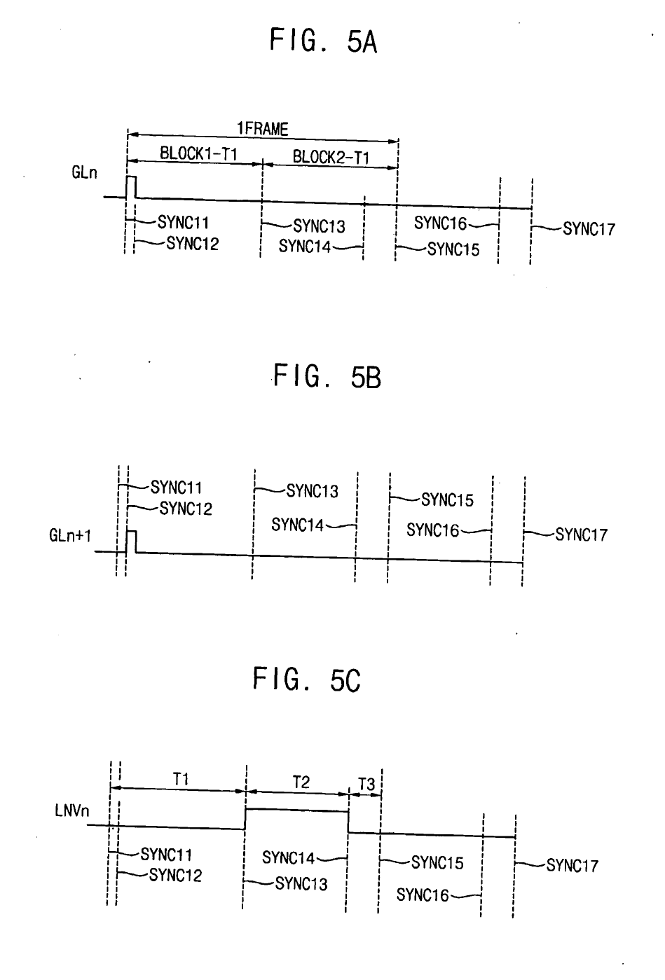

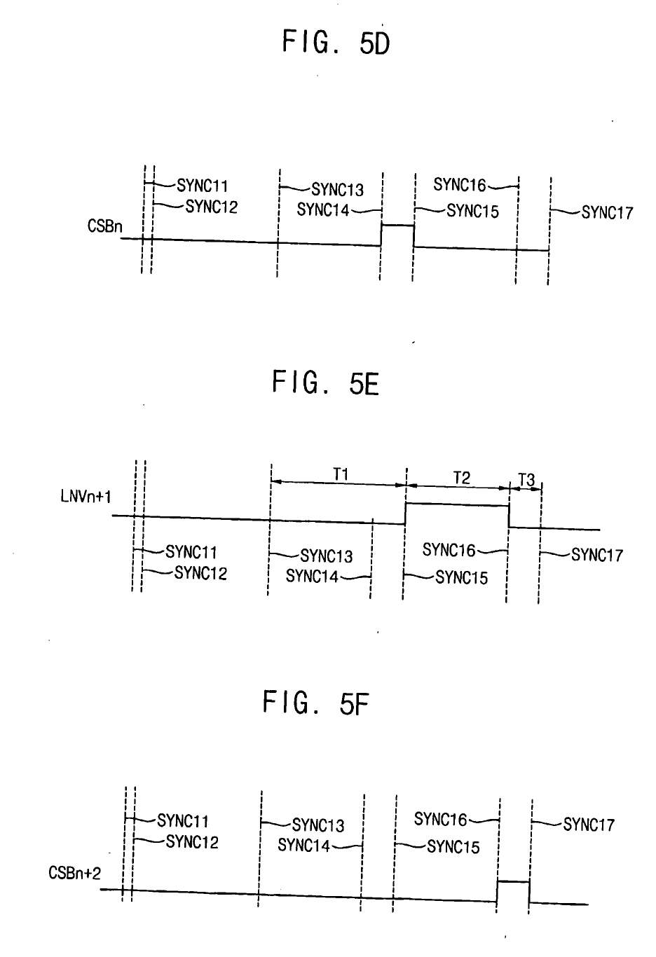

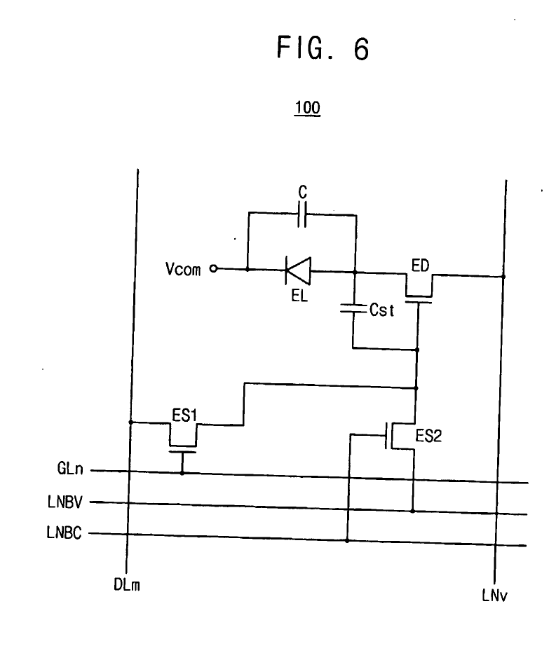

FIG. 3 is a circuit diagram illustrating a display panel in accordance with one embodiment of the present invention. FIGS. 4A to 4D are timing diagrams illustrating a method of driving the display panel shown in FIG. 3. FIGS. 5A to 5F are timing diagrams illustrating another method of driving the display panel shown in FIG. 3. In particular, a unit pixel of the display panel is shown in FIG. 3.

Referring to FIG. 3, the unit pixel 10 of the display panel includes an organic light-emitting element EL, a driving element ED, a first switching element ES1 and a second switching element ES2. The driving element ED controls an operation of the organic light-emitting element EL. The first switching element ES1 selectively applies a data signal to the driving element ED for activating the driving element ED. The second switching element ES2 applies the negative bias signal VDn to the driving element ED.

The organic light-emitting element EL includes a first electrode electrically connected to the driving element ED and a second electrode receiving a common voltage Vcom.

The driving element ED includes an N-channel metal oxide semiconductor (NMOS) transistor having a gate electrode, a drain electrode and a source electrode. The gate electrode of the driving element ED is electrically connected to the first switching element ES1. The drain electrode of the driving element ED is electrically connected to a power supply line LNv. The source electrode of the driving element ED is electrically connected to a first electrode of the organic light-emitting element EL.

The first switching element ES1 includes an NMOS transistor having a gate electrode electrically connected to an n-th gate line GLn, a drain electrode electrically connected to the gate electrode of the driving element ED, and a source electrode electrically connected to an m-th data line DLm.

The second switching element ES2 includes a gate electrode receiving a bias control signal CSB, a source electrode receiving a negative bias signal VDn and a drain electrode electrically connected to the gate electrode of the driving element ED.

Referring to FIGS. 3 to 4D, the method of driving the circuit diagram shown in FIG. 3 will now be described.

When the gate signal is applied to the n-th gate line GLn, the first switching element ES1 is turned on, so that the data signal that is from the m-th data line DLm is applied to the gate electrode of the driving element ED. A charging period Ta represents the time difference between the period during which the gate signal is applied to the gate electrode of the first switching element ES1 and the period during which the data signal is applied to the gate electrode of the driving element ED.

When the data signal is applied to the gate electrode of the driving element ED, the driving element ED is turned on to control the driving current that is from the power supply line LNv. The controlled driving current is applied to the organic light-emitting element EL to activate the organic light-emitting element EL. A discharging period Tb represents the time period for activating the organic light-emitting element EL after the charging period Ta.

The n-th gate line GLn and the m-th data line DLm of each of the unit pixels are activated, in sequence, so that the organic light-emitting element EL in each of unit pixels of a display panel is activated. An image is displayed on the display panel during the discharging period Tb after the charging period Ta.

The bias controlling signal CSB is applied to the gate electrode of the second switching element ES2 after the discharging period Tb to turn on the second switching element ES2. When the second switching element ES2 is turned on, the negative bias signal VDn is applied to the driving element ED to compensate for a change in the threshold voltage Vth of the driving element ED. The threshold voltage Vth changes during the discharging period Tb. A compensating period Tc represents the time period for reducing the change in the threshold voltage Vth of the driving element ED by applying the negative bias signal VDn after the discharging period.

In the method of driving the display panel shown in FIGS. 3 to 4D, the charging period Ta is about half of a frame. The discharging period Tb and the compensating period Tc are less than half a frame long.

When the compensating period Tc is decreased, the amount of time the threshold voltage Vth has to reduce the voltage change is decreased. Thus, the threshold voltage Vth of the driving element ED may not be returned to the initial value that it had before the charging period Ta.

The method shown in FIGS. 4A to 4D requires a process for controlling the driving current after the charging period Ta. This process complicates the driving processes of the unit pixel 10.

Referring to FIGS. 3 and 5A to 5F, the display panel is driven in a block driving method. In the block driving method, each of the pixels in the display panel is divided into two blocks. Alternatively, each of the pixels in the display panel may be divided into a plurality of blocks.

In the block driving method, the discharging period Tb is increased. A shading may be displayed between adjacent blocks, and a flicker may be displayed between adjacent lines.

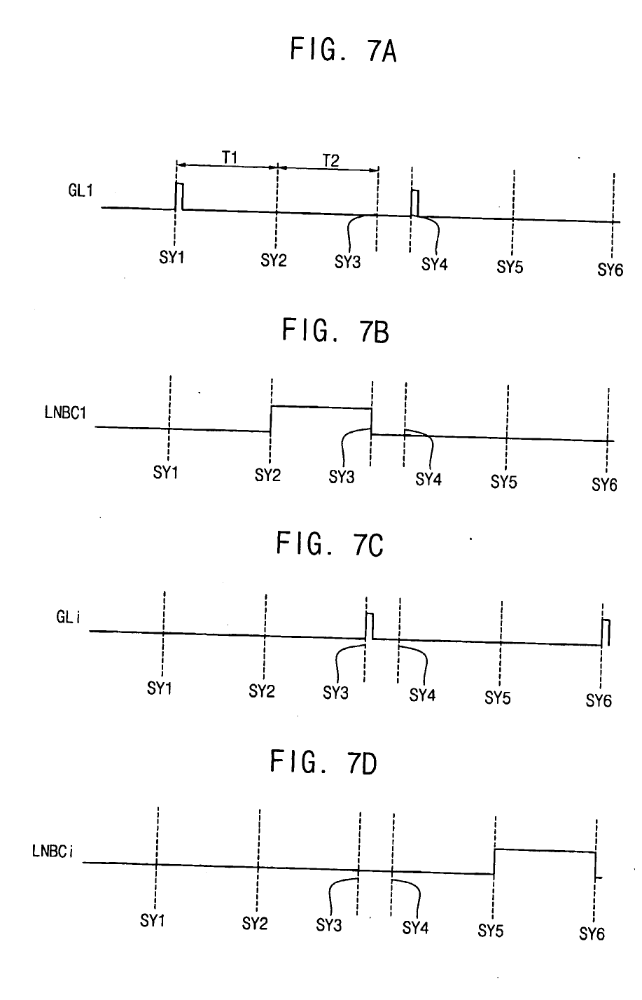

FIG. 6 is a circuit diagram illustrating a display panel in accordance with another embodiment of the present invention.

Referring to FIG. 6, the unit pixel 100 of the display panel includes an organic light-emitting element EL, a first switching element ES1, a bias signal line LNBV, a bias controlling line LNBC, a second switching element ES2 and a driving element ED.

The organic light-emitting element EL includes a first electrode electrically connected to the driving element ED, and a second electrode receiving a common voltage Vcom.

The first switching element ES1 includes an NMOS transistor having a gate electrode electrically connected to an n-th gate line GLn, a drain electrode electrically connected to a gate electrode of the driving element ED, and a source electrode electrically connected to an m-th data line DLm.

The bias signal line LNBV is electrically connected to the second switching element ES2. A negative bias signal VDn having a constant level during one frame is applied to the bias signal line LNBV.

The bias controlling line LNBC is electrically connected to the second switching element ES2. The bias controlling line LNBC may extend substantially parallel to the n-th gate line GLn.

A first bias controlling signal CSB1 is applied to the bias controlling line LNBC during a first time period of a frame. In addition, the data signal is applied to the organic light-emitting element EL during the first time period of the frame. The first bias controlling signal CSB1 has a first power level that is lower than a turn-on voltage of the second switching element ES2. The turn-on voltage may be a threshold voltage.

In addition, a second bias controlling signal CSB2 is applied to the bias controlling line LNBC during a second time period of the frame after the first time period of the frame. The second bias controlling signal has a second power level that is greater than the turn-on voltage of the second switching element ES2.

The second switching element ES2 may include an NMOS transistor having a gate electrode electrically connected to the bias controlling line LNBC, a source electrode electrically connected to the bias signal line LNBV and a drain electrode electrically connected to a gate electrode of the driving element ED.

The driving element ED may include an NMOS transistor having a gate electrode electrically connected to the first switching element ES1, a drain electrode electrically connected to the first electrode of the organic light-emitting element EL, and a source electrode electrically connected to a power supply line LNv.

A capacitor C is electrically connected to the organic light-emitting element EL, in parallel, so that a constant current may be applied to the organic light-emitting element EL.

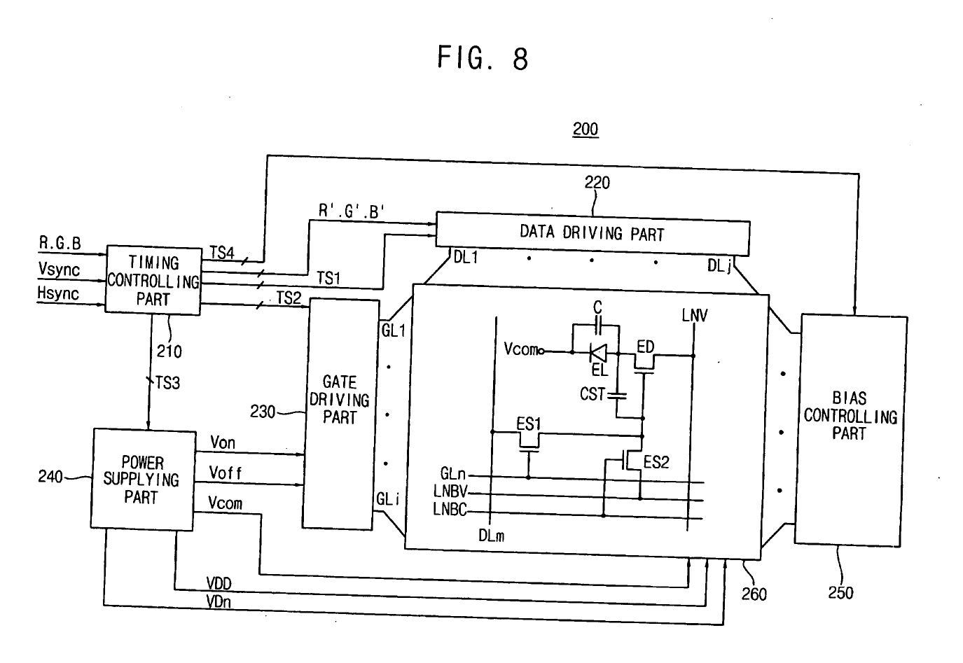

FIGS. 7A to 7D are timing diagram illustrating a method of driving the display panel shown in FIG. 6.

Referring to FIGS. 6 to 7D, the method of driving the display panel having the organic light-emitting element EL is described as follows.

A driving voltage VDD having a constant level, the negative bias signal VDn having a constant level and the first bias controlling signal CSB1 are applied to the power supply line LNv, the bias signal line LNBV and to the second switching element ES2, respectively.

When a first gate line GL1 is activated, a data signal that is from the first data line DL1 is applied to the driving element ED, so that the driving element ED is turned on. In particular, the driving element ED is turned on when the driving voltage VDD is constantly applied to a first power supply line LN1, so that the charging period Ta shown in FIG. 4 may be omitted. When the charging period Ta is omitted, the response speed of the organic light-emitting element EL may be quicker.

In FIGS. 6 to 7D, the driving element ED is driven without the charging period Ta, so that a driving current corresponding to the data signal is applied to the organic light-emitting element EL. Therefore, organic light-emitting element EL is activated to display an image. A first time period Ti of a frame represents a time for driving the organic light-emitting element EL after the gate line is activated.

The first bias controlling signal CSB1 has a lower voltage level than a turn-on voltage of the second switching element ES2, so that the second switching element ES2 is turned off. When the second switching element ES2 is turned off, the organic light-emitting element EL remains activated.

The second bias controlling signal CSB2 that is from the first bias controlling line LNBC1 is applied to the gate electrode of the second switching element ES2 after the first time period T1.

The second bias controlling signal CSB2 has a greater level than the turn-on voltage of the second switching element ES2, so that the second switching element ES2 is turned on. When the second switching element ES2 is turned on, the negative bias signal VDn that is from the bias signal line LNBV is applied to the driving element ED.

For example, a level of the data signal may be about 3 V to about 13 V, and a level of the negative bias signal VDn may be no more than about −15 V. That is, an absolute value of the level of the negative bias signal VDn may be no less than 15 V.

In FIGS. 6 to 7D, the negative bias signal VDn is applied to the driving element ED to reduce the degradation of a threshold voltage of the driving element ED by the data signal. The degradation of the threshold voltage is the change of the threshold voltage. A second time period T2 represents a time for applying the second bias controlling signal CSB2 to the gate electrode of the second switching element ES2 to apply the negative bias signal VDn to the driving element ED.

When the negative bias signal VDn is applied to the driving element ED, the negative bias VDn may be charged in a storage capacitor Cst. The second time period T2 may be changed.

The negative bias signal VDn is applied to the degraded driving element ED during the second time period T2 to at least partially reduce the degradation of the degraded driving element ED. The degraded driving element ED is degraded during the first time period T1. The first time period T1 may have substantially the same length as the second time period T2. Alternatively, the first time period T1 may be different from the second time period T2.

The second time period T2 is determined by the time for applying the second bias controlling signal CSB2 to the gate electrode of the second switching element ES2. For example, the second time period T2 may be a half of a frame. That is, the first time period T1 for driving the driving element ED is a half of the frame, and the second time period T2 for applying the negative bias signal VDn to the driving element ED is another half of the frame, thereby maximizing the amount of the amount by which the driving element ED is reduced.

When the negative bias signal VDn is applied to the driving element ED, the driving element EL is not active. A driving frequency of the display panel may be no less than about 120 Hz. When the driving frequency of the display panel is less than about 120 Hz, a flicker may be displayed on the display panel. However, in FIGS. 6 to 7D, the driving frequency of the display panel is no less than about 120 Hz to decrease the flicker.

First to i-th gate lines GL1, GL2, . . . GLi are activated, in sequence. In addition, the second bias controlling signal CSB2 is applied to first to i-th bias controlling lines LNBC1, LNBC2, . . . LNBCi, in-sequence. The first to i-th bias controlling lines LNBC1, LNBC2, . . . LNBCi correspond to the first to i-th gate lines GL1, GL2, . . . GLi, respectively. Therefore, the image corresponding to the frame is displayed, and the degradation of the driving element ED of each of the unit pixels is reduced.

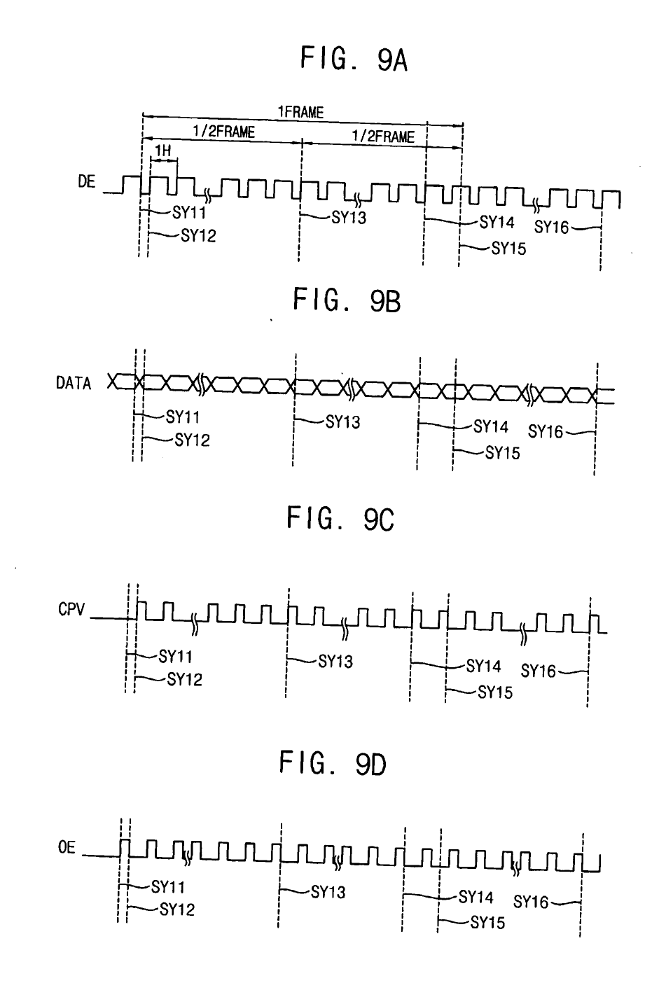

FIG. 8 is a block diagram illustrating a display device in accordance with one embodiment of the present invention.

Referring to FIG. 8, the display device 200 includes a timing controlling part 210, a data driving part 220, a gate driving part 230, a power supplying part 240, a bias controlling part 250 and a display panel 260.

The timing controlling part 210 generates first, second, third and fourth timing signals TS1, TS2, TS3 and TS4 based on first image signals R, G and B and control signals Vsync and Hsync. The control signals Vsync and Hsync control an output of the first image signals R, G and B. The first image signals R, G and B and the control signals Vsync and Hsync are generated from an externally provided graphic controller (not shown).

The timing controlling part 210 applies the first timing signal TS1 and second image signals R′, G′ and B′ to the data driving part 220. In addition, the timing controlling part 210 applies the second timing signal TS2 to the gate driving part 230. Furthermore, the timing controlling part 210 applies the third timing signal TS3 that controls an output of the driving voltage VDD and negative bias signals VDn to the power supplying part 240.

In addition, the timing controlling part 210 applies a fourth timing signal TS4 that controls an application of the negative bias signals VDn to the display panel 260 in sequence to the bias controlling part 250.

The second image signals R′, G′ and B′ and the first timing signal TS1 are applied to the data driving part 220. The data driving part 220 applies analog-typed data voltages to the display panel 260 through the data lines DL1, DL2, . . . DLj, in sequence, based on the second image signals R′, G′ and B′ and the first timing signal TS1 and a reference gray-scale voltage that is from the power supplying part 240.

The gate driving part 230 applies a plurality of gate signals to the display panel 260 through the gate lines GL1, GL2, . . . GLi, in sequence, based on the second timing signal TS2.

The timing controlling part 210 controls the bias controlling part 250 to delay an output of the second bias controlling signal CSB2 shown in FIG. 7B with respect to the first gate signal G1. The second bias controlling signal CSB2 is applied to the display panel 260.

The power supplying part 240 applies gate on/off voltages Von/off to the gate driving part 230 based on the third timing signal TS3. In addition, the power supplying part 240 applies the reference gray-scale voltage to the data driving part 220. Furthermore, the power supplying part 240 applies a common voltage Vcom and a driving voltage VDD to the display panel 260. In addition, the power supplying part 240 generates negative bias signals VDn, and applies the negative bias signals VDn to the display panel 260.

The bias controlling part 250 generates the second bias controlling signals CSB2, and applies the second bias controlling signals CSB2 to bias controlling lines LNBC, respectively, based on the fourth timing signal TS4. The bias controlling part 250 generates the second bias controlling signals CSB2 to apply the negative bias signals VDn that are from the power supplying part 240 to the display panel 260.

The number of the gate lines of the display panel 260 may be ‘n’. The number of the data lines of the display panel 260 may be ‘m’. The number of the power supply lines LNv may be ‘m’. The number of the bias signal lines LNBV may be ‘m’. The number of the bias controlling lines LNBC may be ‘m’. Each of the unit pixels of the display panel 260 includes an organic light-emitting element EL, a driving element ED, a first switching element ES1 and a second switching element ES2. The display panel of FIG. 8 is substantially the same as in FIGS. 6 and 7A-7D. Thus, the same reference numerals will be used to refer to the same or like parts as those described in FIGS. 6 and 7A-7D and any redundant explanation concerning the above elements will be omitted.

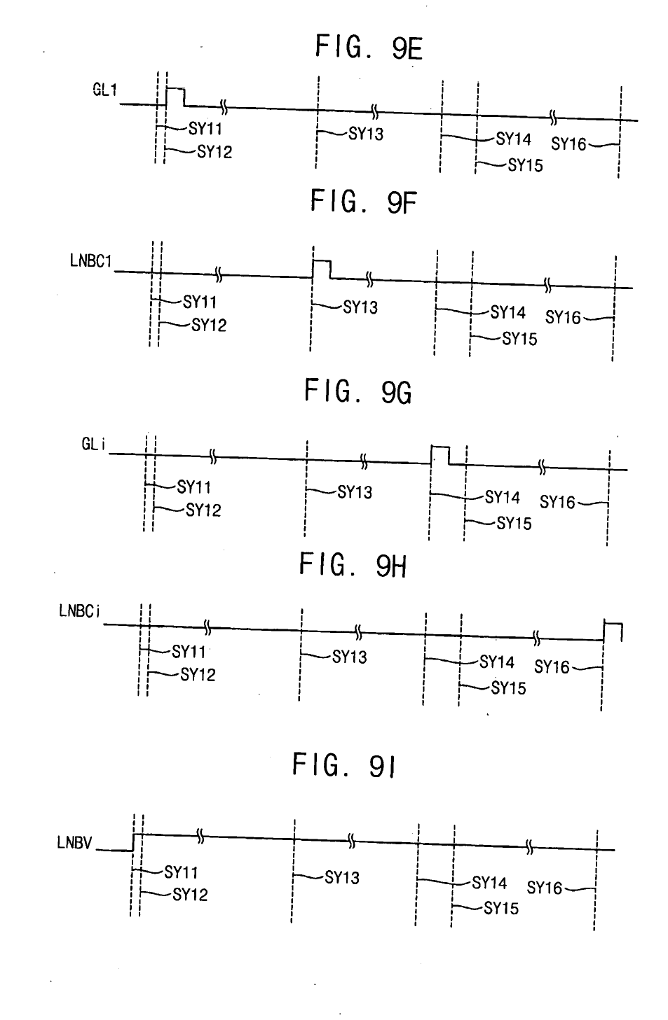

FIGS. 9A to 9I are timing diagrams illustrating a method of driving the display device shown in FIG. 8.

Referring to FIGS. 8 and 9A to 91, the power supplying part 240 applies the driving voltage VDD having a constant level and the negative bias signals VDn to the display panel 260 based on the third timing signal TS3. In addition, the power supplying part 240 applies the gate on/off voltages Von/off to the gate driving part 230, and applies the common voltage Vcom to the display panel 260.

The timing controlling part 210 applies the second image signals R′, G′ and B′ to the data driving part 220 based on a data enable signal DE.

The data driving part 220 converts the data signals into analog-type data voltages, and applies the analog-typed data voltages to the data lines DL1, DL2, . . . DLj of the display panel 260, in sequence.

In addition, the timing controlling part 210 applies the gate enable signal OE to the gate driving part 230. The gate driving part 230 applies the gate signals to the gate lines GL1, GL2, . . . GLi of the display panel 260 based on the gate enable signal OE, thereby turning on the first switching elements ES1 that are electrically connected to the gate lines GL1, GL2, . . . GLi, in sequence.

When the first switching elements ES1 are turned on, in sequence, the data voltages that are from the data lines DL1, DL2, . . . DLj are applied to the driving elements ED that are formed in each of the unit pixels, in sequence, thereby turning-on the driving elements ED in sequence.

Each of the driving elements ED that is turned on by the data voltages applies a driving current that is caused by a voltage difference between a voltage applied to the power supply line LNv and a voltage applied to the common voltage Vcom to each of the organic light-emitting elements EL, thereby activating each of the organic light-emitting elements EL.

The bias controlling part 250 blocks the negative bias signals VDn that are from the bias voltage line LNBV from being transferred to the driving elements ED during a first time period T1 for driving the organic light-emitting elements EL.

The bias controlling part 250 generates first bias controlling signals CSB1 to the bias controlling lines LNBC based on the fourth timing signal TS4, in sequence. Each of the first bias controlling signals CSB1 has a first power level that is lower than a turn-on voltage of the second switching element ES2.

Each of the second switching elements ES2 is turned off by each of the first bias controlling signal CSB1 to block each of the negative bias signals VDn from being applied to each of the driving elements ED.

When each of the driving elements ED is degraded by each of the data signals during the first time period T1, the threshold voltage of each of the driving elements ED is changed. The organic light-emitting elements radiate light during the first time period T1. Each of the organic light-emitting elements EL is then deactivated to reduce a change in the threshold voltage of each of the driving elements ED.

In particular, the bias controlling part 250 applies the negative bias signals VDn that are from the power supplying part 240 to the driving elements ED, in sequence, based on the fourth timing signal TS4.

That is, the bias controlling part 250 generates the second bias controlling signals CSB2 based on the fourth timing signal TS4 to apply the second bias controlling signals CSB2 to the bias controlling lines LNBC, in sequence. Each of the second bias controlling signals CSB2 has a greater voltage level than the turn-on voltage of each of the second switching elements ES2.

Therefore, the second switching elements ES2 that are electrically connected to the bias controlling lines LNBC are turned on, in sequence. The negative bias signals VDn are applied to the driving elements ED, in sequence, thereby negating the degradation of the threshold voltage of the driving elements ED.

Timing and time period of an application of each of the negative bias signals VDn to each of the unit pixels of the display panel may be changed based on the second bias controlling signals CSB2. The bias controlling part 250 generates the second bias controlling signals CSB2 based on the fourth timing signal TS4.

The negative bias signals VDn are selectively applied to the driving elements ED based on the driving voltage VDD, the negative bias signals VDn and the bias controlling signals CSB1 and CSB2 to reduce the degradation of the driving elements ED. Each of the driving voltage VDD and the negative bias signal VDn may have a constant level.

According to the present invention, the charging period is eliminated using the constant driving voltage to increase the time for negating or reducing the degradation of the driving elements for driving the organic light-emitting elements, thereby maximizing the time period of the degradation reduction. The degradation of the driving elements for driving the organic light-emitting elements may be compensated to maximize the time period of the degradation reduction.

In addition, the display panel is not driven through the block driving method for increasing the time for driving the organic light-emitting elements, thereby decreasing the shading and flicker.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A method of driving an organic light-emitting element comprising a first switching element electrically connected to a gate line and a data line, a second switching element electrically connected to a bias controlling line and a bias signal line, and a driving element electrically connected to each of the first switching element and the second switching element to drive the organic light-emitting element, the method comprising:
activating the organic light-emitting element during a first time period of a frame; and
deactivating the organic light-emitting element during a second time period of the frame.

2. The method of claim 1, wherein the organic light-emitting element is activated by:
applying a gate signal to the gate line to turn on the first switching element; and
applying a data signal to the driving element through the data line based on the turning-on of the first switching element to activate the organic light-emitting element.

3. The method of claim 1, wherein the organic light-emitting element is deactivated by:
applying the bias controlling signal to the bias controlling line to turn on the second switching element; and
applying a negative bias signal to the driving element through the bias signal line based on the turning-on of the second switching element to deactivate the organic light-emitting element.

4. The method of claim 1, wherein the first time period is substantially the same as the second time period.

5. The method of claim 1, wherein the first time period is different from the second time period.

6. The method of claim 1, wherein the first time period is a first half of the frame, and the second time period is a second half of the frame.

7. A display panel comprising:
an organic light-emitting element in a pixel region defined by a gate line transmitting a gate signal, a data line transmitting a data signal, and a power supply line transmitting a driving voltage;
a first switching element controlling an output of the data signal based on an activation of the gate line;
a bias signal line transmitting a negative bias signal;
a bias controlling line transmitting a bias controlling signal;
a second switching element controlling an output of the negative bias signal based on an activation of the bias controlling line; and
a driving element activating the organic light-emitting element based on the data signal that is from the first switching element during a first time period of a frame, and deactivating the organic light-emitting element based on the negative bias signal that is from the second switching element during a second time period of the frame.

8. The display panel of claim 7, further comprising a storage capacitor including:
a first electrode electrically connected to the driving element and the second switching element; and
a second electrode electrically connected to the organic light-emitting element.

9. The display panel of claim 7, wherein the second switching element comprises:
a gate electrode electrically connected to the bias controlling line;
a source electrode electrically connected to the bias signal line; and
a drain electrode electrically connected to the driving element.

10. The display panel of claim 7, wherein a negative bias signal having a constant level is applied to the bias signal line.

11. The display panel of claim 10, wherein a level of the negative bias signal has a greater absolute value than a maximum level of the data signal.

12. The display panel of claim 7, wherein the bias controlling line extends substantially parallel to the gate line.

13. A display device comprising:
a data driving part generating a data signal;
a voltage generating part generating a negative bias signal;
a gate driving part generating gate signals, in sequence;
a bias controlling part generating bias controlling signals, in sequence; and
a display panel including:
an organic light-emitting element; and
a driving element activating the organic light-emitting element based on the gate signal and the data signal, and deactivating the organic light-emitting element based on the bias controlling signal and the negative bias signal.

14. The display device of claim 13, further comprising a timing controlling part that controls the gate driving part and the bias controlling part so that the bias controlling signal is delayed by a predetermined time with respect to the gate signal.

15. The display device of claim 14, wherein the predetermined time is shorter than the period of a frame.

16. The display device of claim 13, wherein the display panel further comprises:
a first switching element controlling an output of the data signal to apply the controlled data signal to the organic light-emitting element;
a bias signal line transmitting a negative bias signal;
a bias controlling line transmitting a bias controlling signal; and
a second switching element controlling an output of the negative bias signal based on activation of the bias controlling line, and
the driving element activates the organic light-emitting element based on the data signal that is from the first switching element during a first time period of a frame, and deactivates the organic light-emitting element based on the negative bias signal that is from the second switching element during a second time period of the frame.

17. The display device of claim 13, wherein the bias controlling part generates a first bias controlling signal based on the activation of the organic light-emitting element, and the first bias controlling signal has a lower voltage level than a turn-on voltage of the second switching element.

18. The display device of claim 17, wherein the bias controlling part generates a second bias controlling signal based on the deactivation of the organic light-emitting element, and the second bias controlling signal has a greater level than the turn-on voltage of the second switching element.

19. The display device of claim 13, wherein a level of the negative bias signal generated from the voltage generating part has a greater absolute value than a maximum level of the data signal.
